(19) United States
(12) Patent Application Publication
(10) Pub. No.: US 2003/0193450 A1
(43) Pub. Date: Oct. 16, 2003

(54) Apparatus and method for driving a plasma display panel

(75) Inventors: Jun-Young Lee, Cheonan-City (KR); Jin-Sung Kim, Anyang-City (KR)

Correspondence Address: McGuire Woods LLP, Suite 1800, 1750 Tysons Boulevard, McLean, VA, 22102-4215, US

(73) Assignee: Samsung SDI Co., Ltd.

(21) Appl. No.: 10/401,558

(22) Filed: Mar. 31, 2003

(30) Foreign Application Priority Data
Apr. 15, 2002 (KR) 2002-0020397

(51) Int. Cl. G09G 3/28

(52) U.S. Cl. 345/60

(57) ABSTRACT

An apparatus for driving a plasma display panel includes a first signal line and a second signal line for supplying a first voltage and a second voltage, respectively, and a first inductor and a second inductor being to one terminal of a panel capacitor. A first current path is formed from the panel capacitor to the second signal line via the second inductor to reduce a voltage of the panel capacitor from the first voltage to the second voltage. A second current path is formed to recover a current flowing to the second inductor to the first signal line, when the voltage of the panel capacitor is sustained at the second voltage. A third current path is formed from the first signal line to the panel capacitor via the first inductor while the current flowing to the second inductor is recovered, thereby increasing the voltage of the panel capacitor from the second voltage to the first voltage. A fourth current path is formed to recover a current flowing to the first inductor to the first signal line, while the voltage of the panel capacitor is sustained at the first voltage.

### CROSS REFERENCE

This application claims the benefit of Korean Patent Application No. 2002-0020397, filed on Apr. 15, 2002, which is hereby incorporated by reference for all purposes as if fully set forth herein.

### BACKGROUND OF THE INVENTION

1. Field of the Invention

The present invention relates to an apparatus and method for driving a plasma display panel. More specifically, the present invention relates to a driver circuit for plasma display panels.

2. Background Description

In recent years, flat panel displays such as liquid crystal displays (LCD), field emission displays (FED), plasma display panels (PDP), and the like have been actively developed. The PDP is advantageous over other flat panel displays in regard to its high luminance, high luminous efficiency, and wide viewing angle, and accordingly, it is favorable for making a large-scale screen bigger than 40 inches as a substitute for the conventional cathode ray tube (CRT).

The PDP is a flat panel display that uses plasma generated by gas discharge to display characters or images, and it includes, according to its size, more than several scores to millions of pixels arranged in a matrix pattern. Such a PDP is classified into a direct current (DC) type and an alternating current (AC) type according to its discharge cell structure and the waveform of the driving voltage.

The DC PDP has electrodes exposed to a discharge space to allow a DC to flow through the discharge space when voltage is applied. This requires a resistance for limiting the current. In contrast, the AC PDP has electrodes covered with a dielectric layer that naturally form a capacitance component to limit the current and to protect the electrodes from the impact of ions during discharge. This is superior to the DC PDP in terms of longevity.

Typically, the driving method of the AC PDP comprises a reset (initialization) step, an addressing (write) step, a sustain discharge step, and an erase step.

In the reset step, each cell is initialized in order to readily perform a subsequent addressing operation on the cell. In the write step, wall charges are formed on selected “on”-state cells (i.e., addressed cells) in the panel. In the sustain step, a discharge occurs to actually display an image on the addressed cells. In the erase step, the wall charges on the cells are erased to end the sustain discharge.

In the AC PDP, the panel between address electrodes, sustain electrodes, and scan electrodes acts as a capacitance load and is therefore called a panel capacitor. Due to the capacitance of the panel capacitor, reactive power is necessary in order to apply a waveform for addressing or sustain discharge. A circuit for recovering the reactive power and reusing it is called a “power recovery circuit”, some of which are suggested by L. F. Weber in U.S. Pat. Nos. 4,866,349 and 5,081,400.

In conventional power recovery circuits, however, 100% energy recovery is impossible due to turn-on loss of switches and loss due to the circuit itself, such as switching loss during the recovery process. Accordingly, the address voltage and the sustain discharge voltage cannot be changed to a desired voltage using switches performing hard switching that cause a loss of power. Moreover, the rise/fall time of the address voltage is increased in order to reduce the addressing speed.

### SUMMARY OF THE INVENTION

In an aspect of the present invention, there is provided an apparatus for driving a PDP that includes a first inductor and a second inductor; first, second, and third switches; and first, second, and third diodes. The first switch and the first diode are coupled in series between a first power source for supplying a first voltage and a second power source for supplying a second voltage. The contact between the first switch and the first diode is coupled to one terminal of a panel capacitor. The first inductor and second inductor each have one terminal coupled in parallel to the contact between the first switch and the first diode. The second switch is coupled between the first power source and the other terminal of the first inductor. The third switch is coupled between the other terminal of the second inductor and the second power source. The second diode is coupled between the first power source and the other terminal of the second inductor, and the third diode is coupled between the other terminal of the first inductor and the second power source.

In another aspect of the present invention, there is provided an apparatus for driving a PDP that includes a first signal line and a second signal line for supplying a first voltage and a second voltage, respectively, and a first inductor and a second inductor coupled to one terminal of a panel capacitor.

A first current path is formed from the panel capacitor to the second signal line via the second inductor, to reduce a voltage of the panel capacitor from the first voltage to the second voltage. A second current path is formed to recover a current flowing to the second inductor to the first signal line, when the voltage of the panel capacitor is sustained at the second voltage. A third current path is formed from the first signal line to the panel capacitor via the first inductor while the current flowing to the second inductor is recovered, thereby increasing the voltage of the panel capacitor from the second voltage to the first voltage. A fourth current path is formed to recover a current flowing to the first inductor to the first signal line, while the voltage of the panel capacitor is sustained at the first voltage.

The current flowing to the second inductor on the first current path is changed to have a 1/4 sine wave cycle by a resonance between the panel capacitor and the second inductor. Likewise, the current flowing to the first inductor on the third current path is changed to have a 1/4 sine wave cycle by a resonance between the panel capacitor and the first inductor.

In another aspect of the present invention, there is provided a method for driving a PDP. According to the method, the voltage of the panel capacitor, charged to a first voltage, is changed to a second voltage using an LC resonance with a first inductor coupled to the panel capacitor. The terminal voltage of the panel capacitor is sustained at the second voltage while recovering a current flowing to the first inductor to a first power source for supplying the first voltage. Then the voltage of the panel capacitor is changed to the first voltage using an LC resonance with a second inductor coupled to the panel capacitor, while the current flowing to the first inductor is recovered to the first power source. The terminal voltage of the panel capacitor is sustained at the first voltage while recovering a current flowing to the second inductor to the first power source.

### BRIEF DESCRIPTION OF THE DRAWINGS

The accompanying drawings, which are incorporated in and constitute a part of the specification, illustrate an embodiment of the invention, and, together with the description, serve to more fully explain the principles of the invention.

FIG. 1 is an illustration of a PDP according to an embodiment of the present invention.

FIG. 2 is a circuit diagram of a power recovery circuit according to the embodiment of the present invention.

FIGS. 3A, 3B, 3C and 3D are illustrations showing the current paths in the respective modes of the power recovery circuit according to the embodiment of the present invention.

FIG. 4 is a timing diagram of the power recovery circuit according to the embodiment of the present invention.

### DETAILED DESCRIPTION OF PREFERRED EMBODIMENTS

In the following detailed description, only the preferred embodiment of the invention has been shown and described, simply by way of illustration of the best mode of carrying out the invention. As will be realized by one of ordinary skill in the art, the invention is capable of modification in various obvious respects, all without departing from the invention. Accordingly, the drawings and description are to be regarded as illustrative in nature, and not restrictive.

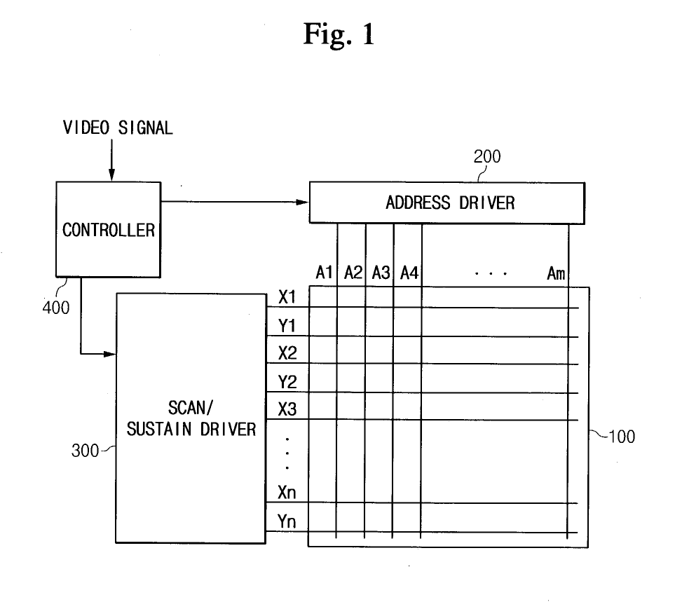

FIG. 1 describes a PDP according to the embodiment of the present invention, wherein the PDP comprises a plasma panel 100, an address driver 200, a scan/sustain driver 300, and a controller 400.

The plasma panel 100 comprises a plurality of address electrodes A₁ to Aₘ arranged in columns, and a plurality of scan electrodes Y₁ to Yₙ and sustain electrodes X₁ to Xₙ alternately arranged in rows. The controller 400 receives an external image signal (i.e., video signal), generates an address drive control signal and a sustain discharge control signal, and applies them to the address driver 200 and the scan/sustain driver 300, respectively.

The address driver 200 receives the address drive control signal from the controller 400, and applies a display data signal to the individual address electrodes for selection of discharge cells to be displayed. The scan/sustain driver 300 receives the sustain discharge control signal from the controller 400, and applies a sustain pulse voltage alternately to the scan and sustain electrodes for a sustain discharge on the selected discharge cells. The address driver 200 and the scan/sustain driver 300 each includes a driver circuit (i.e., power recovery circuit) for recovering reactive power and reusing it.

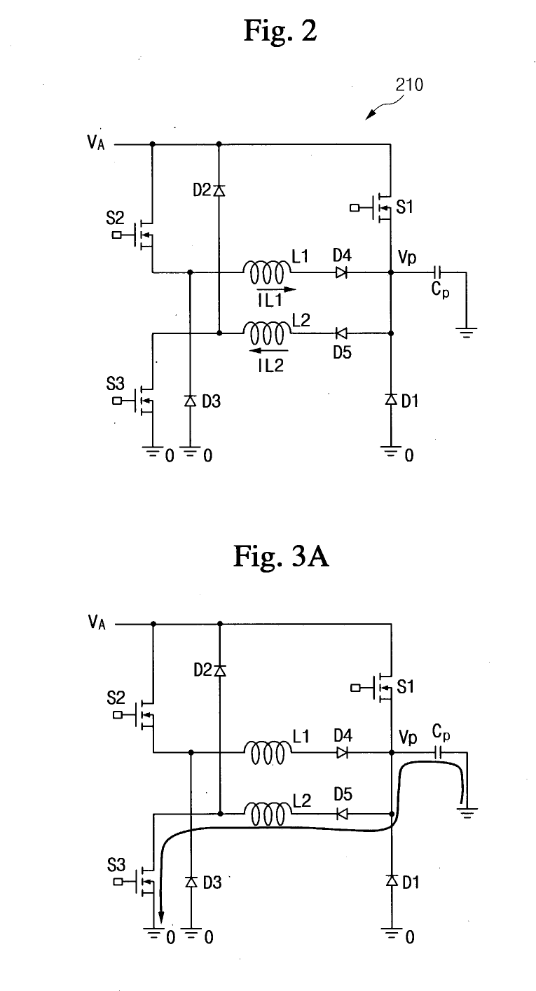

Below is a description of a power recovery circuit 210 as included in the address driver 200 according to the embodiment of the present invention, with reference to FIGS. 2 to 4.

The power recovery circuit 210 according to the embodiment of the present invention is, as shown in FIG. 2, coupled to one electrode of a panel capacitor Cₚ via an address driving IC (not shown). The first voltage applied to the other electrode of the panel capacitor Cₚ and the second voltage applied through the power recovery circuit 210 operate together to be used for selecting discharge cells, and the first voltages is assumed to be a ground voltage 0V in FIG. 2.

The address driving IC is omitted in the discussion to follow and it is assumed that the power recovery circuit is coupled to the panel capacitor Cₚ.

The power recovery circuit 210 includes inductors L₁ and L₂, switches S₁, S₂, and S₃, and diodes D₁, D₂, and D₃. Although the switches S₁, S₂, and S₃ are denoted as MOSFETs in FIG. 2, they are not specifically limited to MOSFETs and may include any switches that perform the same or similar functions. Preferably, these switches have a body diode such as the pn junction separation structure of semiconductor integrated circuits.

The switch S₁ and the diode D₁ are coupled in series between a power source V_{A} supplying an address voltage Vₐ, and a ground terminal 0. To the contact between the switch S₁ and the diode D₁ is coupled the panel capacitor Cₚ. The switch S₂ and the inductor L₁ are coupled in series between the power source V_{A} and the contact between the switch S₁ and the diode D₁. And the inductor L₂ and the switch S₃ are coupled in series between the contact and the ground terminal 0.

The diode D₂ is coupled between the power source V_{A} and a contact between the inductor L₂ and the switch S₃. The diode D₃ is coupled between a contact between the switch S₂ and the inductor L₁, and the ground terminal 0.

The power recovery circuit 210 may further comprise diodes D₄ and D₅ formed on a current path of the switch S₂ and the inductor L₁, and a current path of the switch S₃ and the inductor L₂, respectively. The diodes D₄ and D₅ interrupt current paths that may be caused by the body diodes of the switches S₂ and S₃.

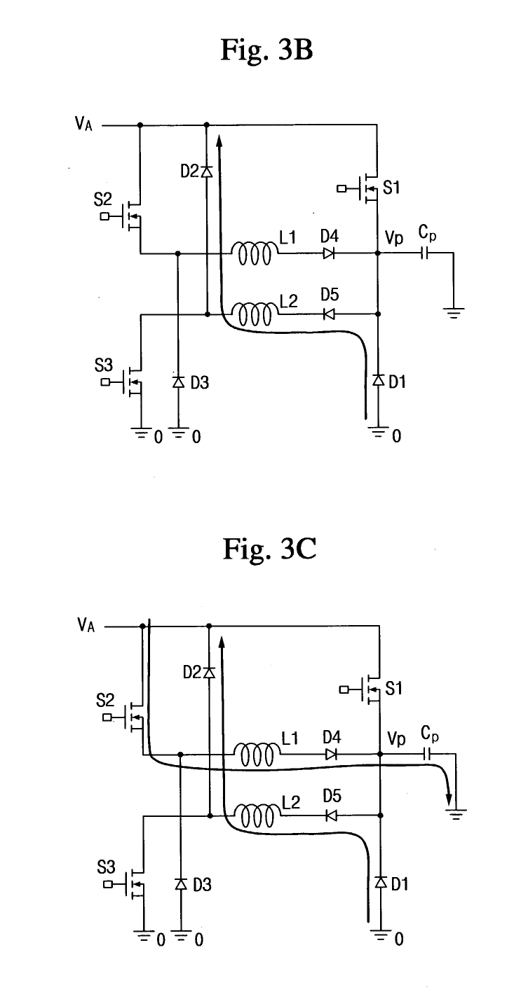

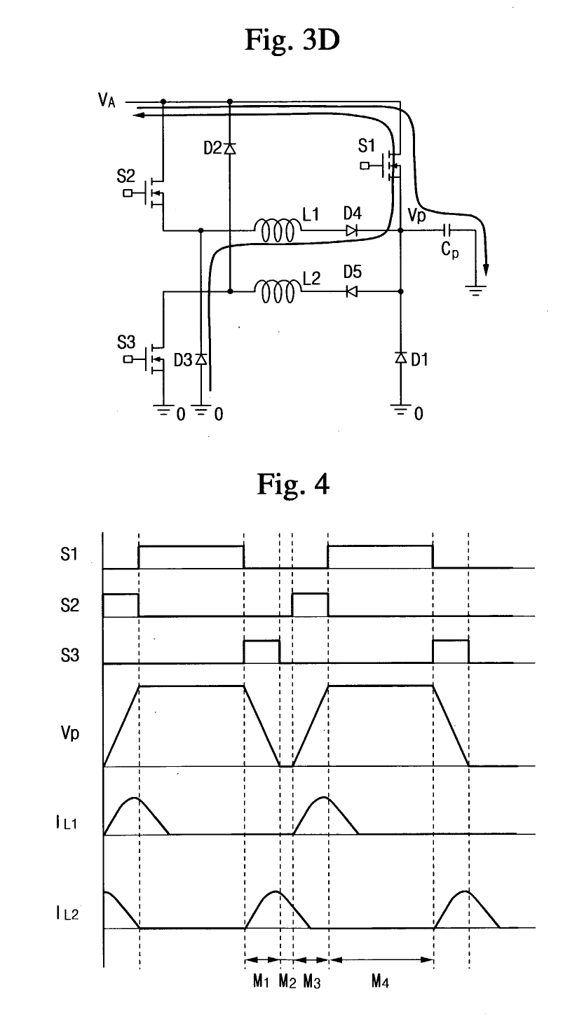

The following description of the operational change of the power recovery circuit 210 according to an embodiment of the present invention is with reference to FIGS. 3A, 3B, 3C, 3D and 4. The operation proceeds in the order of four modes by the manipulation of the switches S₁, S₂, and S₃. The phenomenon called “LC resonance” herein is not a continuous oscillation but a change in voltage and current caused by the combination of the inductor L and the panel capacitor Cₚ when the switch S₂ or S₃ is turned on.

In the embodiment of the present invention, it is assumed that before the start of Mode 1, the switch S₁ is “on” and the switches S₂ and S₃ are “off” to sustain a terminal voltage Vₚ of the panel capacitor Cₚ at the address voltage Vₐ. It is also assumed that the inductance of the inductor L₁ and L₂ are Lₐ₁ and Lₐ₂, respectively.

Referring to FIGS. 3A and 4, in Mode 1 (M1), the switch S1 is turned off and the switch S₃ is turned on to form a current path that includes panel capacitor Cₚ, diode D₅, inductor L₂, and switch S₃. Due to the panel capacitor Cₚ and the inductor L₂, an LC resonance current flows in the current path. This resonance current increases a current I_{L2} flowing to the inductor L₂ to store energy in the inductor L₂, thus reducing the terminal voltage Vₚ of the panel capacitor Cₚ from the address voltage Vₐ to 0V. That is, the energy in the panel capacitor Cₚ is stored in the inductor L₂.

In Mode 2 (M2), the switch S₃ is turned off when the terminal voltage Vₚ of the panel capacitor Cₚ is reduced to the ground voltage. With the switch S₃ off, a current I_{L2} flowing to the inductor L₂ flows on a current path including diode D₁, diode D₅, inductor L₂, and diode D₂, as shown in FIG. 3B, and linearly decreases with a slope of Vₐ/L₂. That is, the energy stored in the inductor L₂ is recovered to the power source V_{A}, and the terminal voltage Vₚ of the panel capacitor Cₚ is sustained at 0V.

Referring to FIG. 3C and, in Mode 3 (M3), the switch S₂ is turned on while the current I_{L2} flowing to the inductor L₂ is decreased. Then a current path is formed that includes switch S₂, inductor L₁, diode D₄, and panel capacitor Cₚ, so that the LC resonance current flows due to the panel capacitor Cₚ and the inductor L₁. This resonance current increases the current I_{1L} flowing to the inductor L₁ to store energy in the inductor L₁, thus raising the terminal voltage Vₚ of the panel capacitor Cₚ from 0V to the address voltage Vₐ.

The current I_{L2} flowing to the inductor L₂ continuously flows to the power source V_{A} until it reaches 0A, so that the energy stored in the inductor L₂ is recovered to the power source V_{A}.

Referring to FIGS. 3D and 4, in Mode 4 (M4), the switch S2 is turned off and the switch S₁ is turned on while the terminal voltage Vₚ of the panel capacitor Cₚ is increased to the power source V_{A}. With the switch S₁ on, a current path is formed that includes address voltage Vₐ, switch S1, and panel capacitor Cₚ. The terminal voltage Vₚ of the panel capacitor Cₚ can therefore be sustained at the address voltage Vₐ.

When the switch S₂ is turned off and, the terminal voltage Vₚ of the panel capacitor Cₚ reaches the address voltage Vₐ, the body diode of the switch S₁ conducts. Then the current I_{L1} flowing to the inductor L₁ flows on a path including diode D₃, inductor L₁, diode D₄, and the body diode of switch S₁, and it linearly decreases to OA with a slope of Vₐ/L₁. That is, the energy stored in the inductor L₁ is recovered to the power source V_{A}.

Subsequently, the procedures of Modes 1 to 4 are repeated so that the terminal voltage Vₚ of the panel capacitor Cₚ is repeatedly switched between the address voltage Vₐ and the ground voltage.

According to the present invention, the terminal voltage Vₚ of the panel capacitor Cₚ is changed when the current flowing to the inductors L₁ and L₂ is increased from 0A to maximum, because of LC resonance. Also, the terminal voltage Vₚ of the panel capacitor Cₚ is increased before the current of the inductors is completely reduced. That is, the terminal voltage Vₚ of the panel capacitor Cₚ is changed using a 1/4 resonance. This enables high-speed addressing, compared with the conventional circuits using a half resonance. In addition, the terminal voltage Vₚ can be completely raised to the address voltage or lowered to the ground voltage irrespective of the power recovery rate.

The energy stored in the inductors L₁ and L₂ is recovered to the address voltage Vₐ, causing no circulating current. The resonance paths during charge and discharge of the panel capacitor Cₚ are separated from each other to reduce the rise/fall time of the address voltage. This can also make the rise time different from the fall time.

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

Having thus described our invention, what we claim as new and desire by Letters Patent is as follows:

1. An apparatus for driving a plasma display panel, which includes a plurality of address electrodes, a plurality of scan electrodes and a plurality of sustain electrodes arranged in pairs, and a panel capacitor formed among the address electrodes, the scan electrodes, and sustain electrodes, the apparatus comprising:
a first switch and a first diode coupled in series between a first power source for supplying a first voltage and a second power source for supplying a second voltage, a contact between the first switch and the first diode being coupled to one terminal of the panel capacitor;
a first inductor and a second inductor, each having one terminal thereof coupled in parallel to the contact between the first switch and the first diode;
a second switch coupled between the first power source and the other terminal of the first inductor;
a third switch coupled between the other terminal of the second inductor and the second power source;
a second diode coupled between the first power source and the other terminal of the second inductor; and
a third diode coupled between the other terminal of the first inductor and the second power source.

2. The apparatus of claim 1, further comprising:
a fourth diode coupled between the first inductor and the panel capacitor; and
a fifth diode coupled between the panel capacitor and the second inductor.

3. The apparatus of claim 1, wherein the first voltage is an address voltage and the second voltage is a ground voltage.

4. The apparatus of claim 1, wherein the first switch has a body diode.

5. An apparatus for driving a plasma display panel, which includes a plurality of address electrodes, a plurality of scan electrodes and a plurality of sustain electrodes arranged in pairs, and a panel capacitor formed among the address electrodes, the scan electrodes and the sustain electrodes, the apparatus comprising:
a first signal line and a second signal line for supplying a first voltage and a second voltage, respectively; and
a first inductor and a second inductor coupled to one terminal of the panel capacitor,
wherein a first current path for reducing a voltage of the panel capacitor from the first voltage to the second voltage is formed from the panel capacitor to the second signal line via the second inductor,
wherein a second current path is formed to recover a current flowing to the second inductor to the first signal line, when the voltage of the panel capacitor is sustained at the second voltage,
wherein a third current path for increasing the voltage of the panel capacitor from the second voltage to the first voltage is formed from the first signal line to the panel capacitor via the first inductor while the current flowing to the second inductor is recovered, and
wherein a fourth current path is formed to recover a current flowing to the first inductor to the first signal line, while the voltage of the panel capacitor is sustained at the first voltage.

6. The apparatus of claim 5, wherein the current flowing to the second inductor on the first current path is changed to have a 1/4 sine wave cycle by a resonance between the panel capacitor and the second inductor.

7. The apparatus of claim 5, wherein the current flowing to the first inductor on the third current path is changed to have a 1/4 sine wave cycle by a resonance between the panel capacitor and the first inductor.

8. The apparatus of claim 5, wherein the terminal voltage of the panel capacitor reaches the first voltage and second voltage when the currents flowing to the first inductor and second inductor are respectively at maximum.

9. The apparatus of claim 5, further comprising:
a first switch coupled between the first inductor and the first signal line; and
a second switch coupled between the second inductor and the second signal line,
wherein the first current path and third current path are formed when the second switch and first switch are turned on, respectively.

10. The apparatus of claim 9, further comprising:
a first diode formed between the second signal line and the one terminal of the second inductor; and
a second diode formed between the other terminal of the second inductor and the first signal line,
the second current path being formed via the first and second diodes.

11. The apparatus of claim 9, further comprising:
a first diode formed between the second signal line and the one terminal of the first inductor; and
a second diode formed between the other terminal of the first inductor and the first signal line,
wherein the fourth current path is formed via the first diode and the second diode.

12. The apparatus of claim 11, further comprising:
a third switch having the second diode as a body diode,
wherein the panel capacitor is sustained at the first voltage when the third switch is turned on.

13. The apparatus of claim 5, wherein the first voltage is an address voltage and the second voltage is a ground voltage.

14. A method for driving a plasma display panel, which includes a plurality of address electrodes, a plurality of scan electrodes and a plurality of sustain electrodes arranged in pairs, and a panel capacitor formed among the address electrodes, the scan electrodes and the sustain electrode, the method comprising steps of:
(a) changing a voltage of the panel capacitor charged to a first voltage to a second voltage using an LC resonance with a first inductor coupled to the panel capacitor;
(b) sustaining the terminal voltage of the panel capacitor at the second voltage while recovering a current flowing to the first inductor to a first power source for supplying the first voltage;
(c) changing the voltage of the panel capacitor to the first voltage using an LC resonance with a second inductor coupled to the panel capacitor, while the current flowing to the first inductor is recovered to the first power source; and
(d) sustaining the terminal voltage of the panel capacitor at the first voltage while recovering a current flowing to the second inductor to the first power source.

15. The method of claim 14, wherein the current flowing to the first inductor is maximum when the voltage of the panel capacitor reaches the second voltage, and
wherein the current flowing to the second inductor is maximum when the voltage of the panel capacitor reaches the first voltage.

16. The method of claim 14, wherein the step (a) further comprises a step of:
switching a first switch coupled between the first inductor and a second power source for supplying the second voltage to form the LC resonance, and
wherein the step (c) further comprises a step of:
switching a second switch coupled between the second inductor and the first power source to form the LC resonance.

17. The method of claim 14, wherein the step (b) further comprises a step of:
recovering the current flowing to the first inductor with a current path including a second power source for supplying the second voltage, the first inductor and the first power source,
wherein the step (d) further comprises a step of:
recovering the current flowing to the second inductor with a current path including the second power source, the second inductor and the first power source.

18. The method of claim 14, wherein the step (d) further comprises a step of:
sustaining the terminal voltage of the panel capacitor at the first voltage by switching a switch coupled between the panel capacitor and the first power source.

19. The method of claim 14, wherein the first voltage is an address voltage and the second voltage is a ground voltage.
